(19) United States
(12) Patent Application Publication
(10) Pub. No.: US 2026/0084906 A1
(43) Pub. Date: Mar. 26, 2026

(54) BULK MATERIAL HANDLING METHODS, SYSTEMS, SUBSYSTEMS, AND APPARATUSES

(71) Applicant: Owens-Brockway Glass Container Inc., Perrysburg, OH (US)

(72) Inventors: Philip J. Rausch, Perrysburg, OH (US); Kirk Holmes, Perrysburg, OH (US); Karin Gabriela Bastarrachea, St Kilda (AU); Steven Will, Sylvania, OH (US); Roger Smith, Perrysburg, OH (US); Manfred Robert Romstöck, Freudenberg (DE); Guenther Josef Mlynar, Wertheim-Bettingen (DE)

(21) Appl. No.: 19/197,311

(22) Filed: May 2, 2025

Related U.S. Application Data
(62) Division of application No. 17/492,554, filed on Oct. 1, 2021, now Pat. No. 12,291,410.
Application No. 17/492,554 is a continuation-in-part of application No. 17/061,302, filed on Oct. 1, 2020, now Pat. No. 11,912,608.

(51) Int. Cl. B65G 53/04; B65G 3/04; B65G 43/00; G01G 17/04

(52) U.S. Cl. CPC B65G 53/04; B65G 3/04; B65G 43/00; G01G 17/04; B65G 2201/042

(57) ABSTRACT

A bulk material handling method includes: a) receiving and pneumatically conveying bulk material via pressurized dilute phase, dense phase, and/or hybrid dilute/dense phase, and/or vacuum drawn conveyance into bulk material containers; b) storing the bulk material in the containers; c) dispensing the bulk material into a bulk material transporter; d) transporting the transporter to a bulk material transmitting vessel; and e) discharging the bulk material into the transmitting vessel, including releasing the bulk material from the transporter into the transmitting vessel, and pneumatically transmitting the bulk material to downstream bulk material processing equipment. A method of constructing a bulk material handling system includes pre-assembling modules of the bulk material handling system at an equipment fabricator, shipping the modules of the pre-assembled system from the fabricator to a product manufacturer using intermodal freight containers, and erecting the pre-assembled system from the modules at the product manufacturer.

### TECHNICAL FIELD

This patent application discloses innovations to material handling and, more particularly, to bulk material handling including pneumatic receiving and conveying, storing, gravity dispensing, vehicular transporting, and pneumatic discharging of bulk materials.

### BACKGROUND

A conventional glass “batch house” includes a custom architectural installation specifically designed for glass manufacturing, and a glass batch house system supported and sheltered by the architectural installation. With reference to prior art FIGS. 1A through 1E, a conventional glass container batch house is illustrated and described as an example. Those of ordinary skill in the art would recognize that other glass batch houses, for example, for producing glass fibers, glass display screens, architectural glass, vehicle glass, or any other glass products, share many aspects with a glass container batch house. The conventional custom glass batch house architectural installation includes a feedstock subsystem that includes a “batch house”building located outside of the factory building.

The batch house building towers over the factory building and is generally configured to receive and store feedstock or “glass batch” including raw materials, for example, sand, soda ash, and limestone, and also including cullet in the form of recycled, scrap, or waste glass. The batch house is usually several stories tall, and includes a covered unloading platform and a pit to receive the glass batch from underneath railcars or trucks that arrive loaded with glass batch materials. The batch house also includes multi-story silos to store the glass batch, and glass batch elevators and glass batch conveyors to move the glass batch from the pit to tops of the silos. The batch house further includes cullet pads at ground level to receive and store cullet, crushers to crush cullet to a size suitable for melting, and cullet elevators and conveyors to move crushed cullet to one of the silos in the batch house. The batch house additionally includes batch mixers to mix the glass batch received from the silos, conveyors with scales to weigh and deliver each glass batch material from the silos to the mixers, mixer conveyors to move the glass batch from the mixers to the hot-end subsystem, and dust collectors to collect dust from the various equipment.

With reference to FIGS. 1B-1E, the height of a conventional batch house architectural installation is about 95 feet (29 meters) above a forming floor level and about 18 feet (5.5 meters) below the forming floor level, the length of the batch house architectural installation is about 95 feet (29 meters), and the width of the batch house architectural installation is about 61 feet (18.5 meters).

Accordingly, the batch house requires a specialized, dedicated, and permanent architectural installation including a pit, and a two to three story building. The time to construct a new glass batch house of the conventional type is about one to two years. And a conventional batch house cannot be easily relocated from one plant to another. The batch house installation occupies a large footprint of about 5,800 square feet or about 540 square meters, and a large volumetric envelope of about 655,000 cubic feet or about 18,550 cubic meters. Such a size for a conventional glass container batch house supports a production output of about 140 tons of glass per day. Accordingly, a capacity-adjusted size of the batch house can be characterized by the volumetric envelope of the batch house divided by the production output enabled by the batch house, which is about 133 cubic meters per each ton of glass produced per day. As used herein, the term “about” means within plus or minus five percent.

### SUMMARY OF THE DISCLOSURE

The present disclosure embodies a number of aspects that can be implemented separately from or in combination with each other.

In accordance with an aspect of the present disclosure, a method of constructing a bulk material handling system includes pre-assembling modules of the bulk material handling system at an equipment fabricator to establish pre-assembled modules, shipping the pre-assembled modules from the equipment fabricator to a product manufacturer using intermodal freight containers, and erecting the bulk material handling system from the pre-assembled modules at the product manufacturer.

In accordance with another aspect of the present disclosure, a bulk material handling method includes receiving bulk material and pneumatically conveying the bulk material via at least one of pressurized dilute phase, pressurized dense phase, hybrid dilute/dense phase, or vacuum draw conveyance into bulk material containers. The method also includes storing the bulk material in the bulk material containers, dispensing the bulk material from the bulk material containers into a bulk material transporter, and transporting the bulk material transporter from the bulk material containers to a bulk material discharging system. The method further includes discharging the bulk material out of the bulk material transporter, including releasing the bulk material from the bulk material transporter into a bulk material transmitting vessel, and pneumatically transmitting the bulk material out of the bulk material transmitting vessel to downstream bulk material processing equipment.

### BRIEF DESCRIPTION OF THE DRAWINGS

FIG. 1A is a front perspective schematic view of a conventional glass factory and glass batch house for the factory, in accordance with the prior art, and drawn to scale.

FIG. 1B is another front perspective view of the factory and glass batch house of FIG. 1A.

FIG. 1C is a rear perspective schematic view of the factory and glass batch house of FIG. 1A.

FIG. 1D is an elevational schematic view of the factory and glass batch house of FIG. 1A.

FIG. 1E is a plan schematic view of the factory and glass batch house of FIG. 1A.

FIG. 1 is a front perspective schematic view of a glass factory and bulk material handling system for the factory, in accordance with an illustrative embodiment of the present disclosure, and drawn to scale.

FIG. 2 is another front perspective view of the factory and system of FIG. 1.

FIG. 3 is a rear perspective schematic view of the factory and system of FIG. 1.

FIG. 4 is an elevational schematic view of the factory and system of FIG. 1.

FIG. 5 is a plan schematic view of the factory and system of FIG. 1.

FIG. 6A is a perspective view of a bulk material handling system in accordance with another illustrative embodiment of the present disclosure, illustrating a building having a roof, cladding, elevator, stairs, ladders, and platforms.

FIG. 6B is different perspective view of the system of FIG. 6A, illustrating the building with the roof, cladding, elevator, stairs, ladders, and platforms.

FIG. 7A is another perspective view of the system corresponding to FIG. 6A, without the roof, cladding, elevator, and ladders.

FIG. 7B is another perspective view of the system corresponding to FIG. 6B, without the roof, cladding, elevator, and ladders.

FIG. 8 is a top view of the system of FIG. 6A.

FIG. 9 is a bottom view of the system of FIG. 6A.

FIG. 10 is an upstream end view of the system of FIG. 6A.

FIG. 11 is a downstream end view of the system of FIG. 6A opposite that of FIG. 10.

FIG. 12 is a side view of the system of FIG. 6A.

FIG. 13 is another side view of the system of FIG. 6A opposite that of FIG. 12.

FIG. 14 is a perspective view of a modular wall of the system of FIG. 6A.

FIG. 15 is a perspective view of a dispenser modular frame of the system of FIG. 6A.

FIG. 16 is a perspective view of silo modular frame of the system of FIG. 6A.

FIG. 17A is a perspective view of a multi-purpose modular frame of the system of FIG. 6A.

FIG. 17B is a perspective view of another multi-purpose modular frame of the system of FIG. 6A.

FIG. 18 is a perspective view of a rack carrying additional multi-purpose modular frames and related equipment of the system of FIG. 6A.

### DETAILED DESCRIPTION

In general, a new bulk material handling system is illustrated and described with reference to a glass feedstock handling system for a glass container factory as an example. Those of ordinary skill in the art would recognize that other glass factories, for example, for producing glass fibers, glass display screens, architectural glass, vehicle glass, or any other glass products, share many aspects with a glass container factory. Accordingly, the presently disclosed and claimed subject matter is not necessarily limited to glass containers, glass container feedstock handling systems, and glass container factories and, instead, encompasses any glass products, glass product feedstock handling systems, and glass product factories. Moreover, the presently disclosed and claimed subject matter is not necessarily limited to bulk material handling for the glass industry and, instead, encompasses any products, bulk material handling systems, and factories in any industry in which bulk material handling is useful.

Although conventional glass batch houses and methods enable efficient production of high-quality products for large-scale production runs, the presently disclosed subject matter introduces a revolutionary bulk material handling system that is simpler than a conventional batch house, is modular and mobile, and is more compact and economical at least for smaller scale production runs or incremental additions to existing large-scale production runs. More specifically, in accordance with an aspect of the present disclosure, the system may include prefabricated modular equipment configurations that involve rapid construction of the system in about three to six months, simplify production capacity expansion in smaller increments and at lower capital cost than conventional glass batch houses, and render the system mobile and easily moved from one standard industrial location to another, completely unlike conventional glass batch houses that require dedicated, customized, permanent installations that take a much longer time to construct. In accordance with another aspect of the present disclosure, the bulk material handling system need not include a conventional batch house or any one or more of the following conventional batch house elements: basements or pits, for example, to receive glass batch from underneath railcars or trucks, or glass batch elevators, or glass batch mixers. Accordingly, a permanent site and facility in a heavy industrial zone need not be purchased; rather, an existing site and facility for the system can be temporarily leased in a light industrial zone, until it is desirable to relocate the system to another site and facility. In accordance with a further aspect of the present disclosure, the new bulk material handling system has a footprint and volumetric envelope that are significantly reduced compared to that of conventional glass batch houses, as described in further detail below.

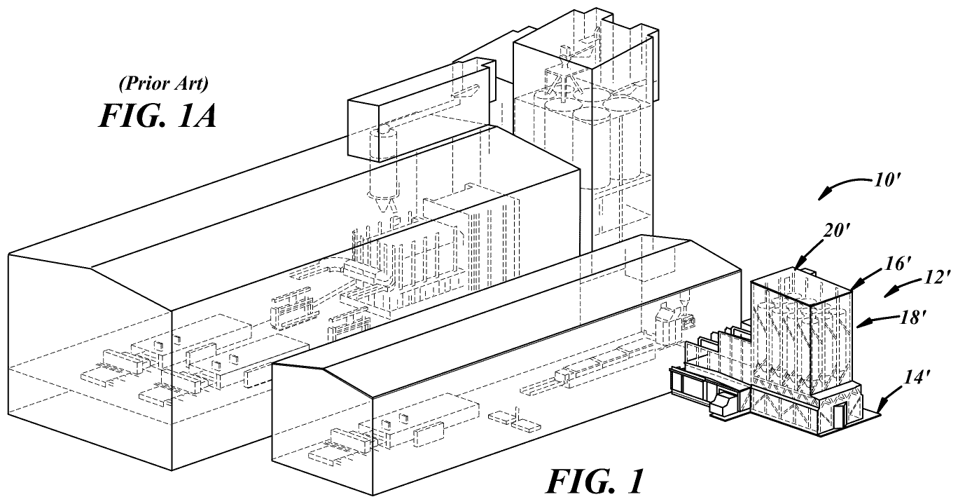

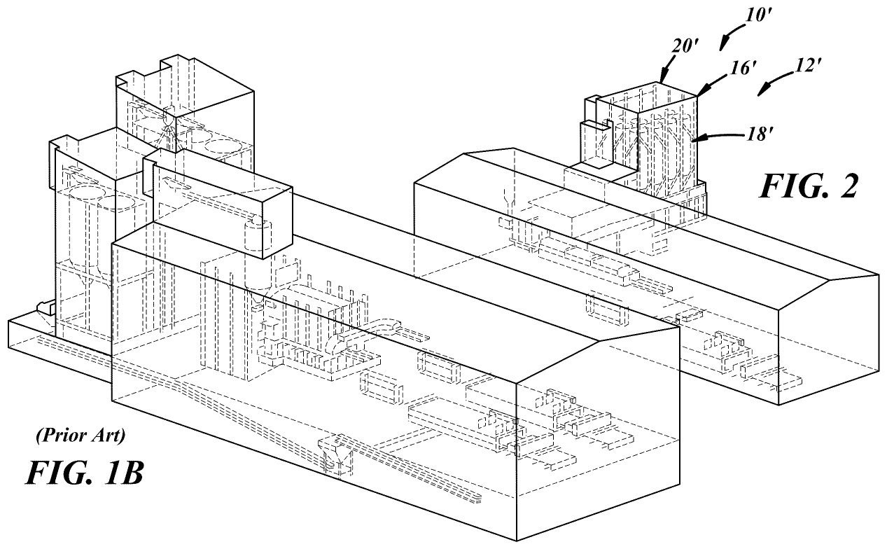

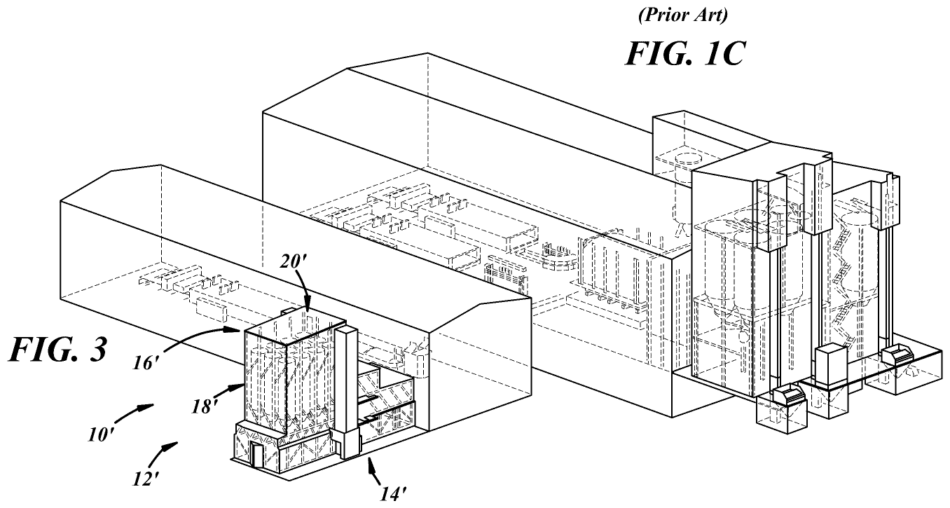

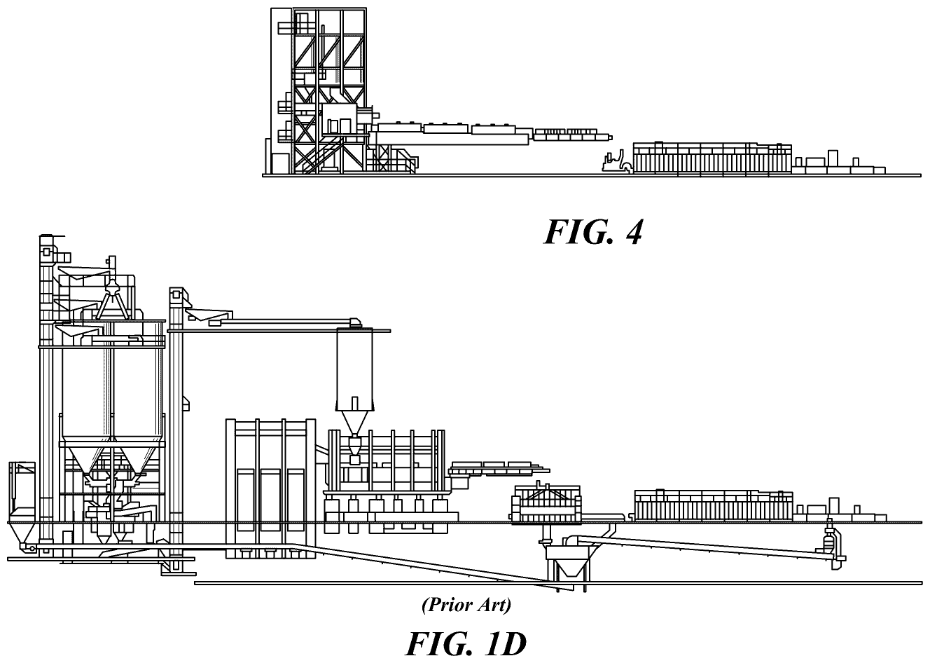

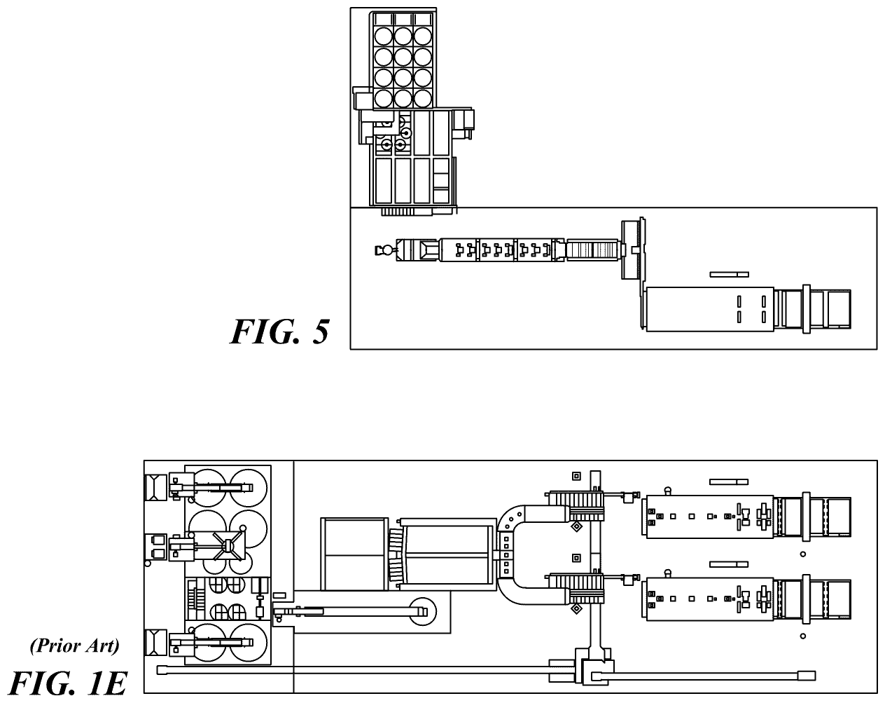

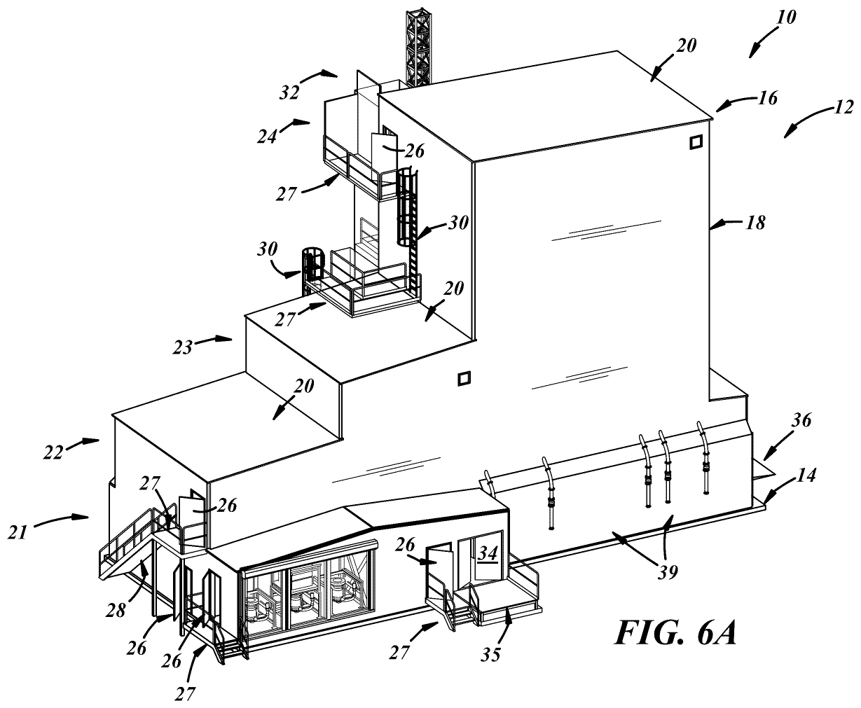

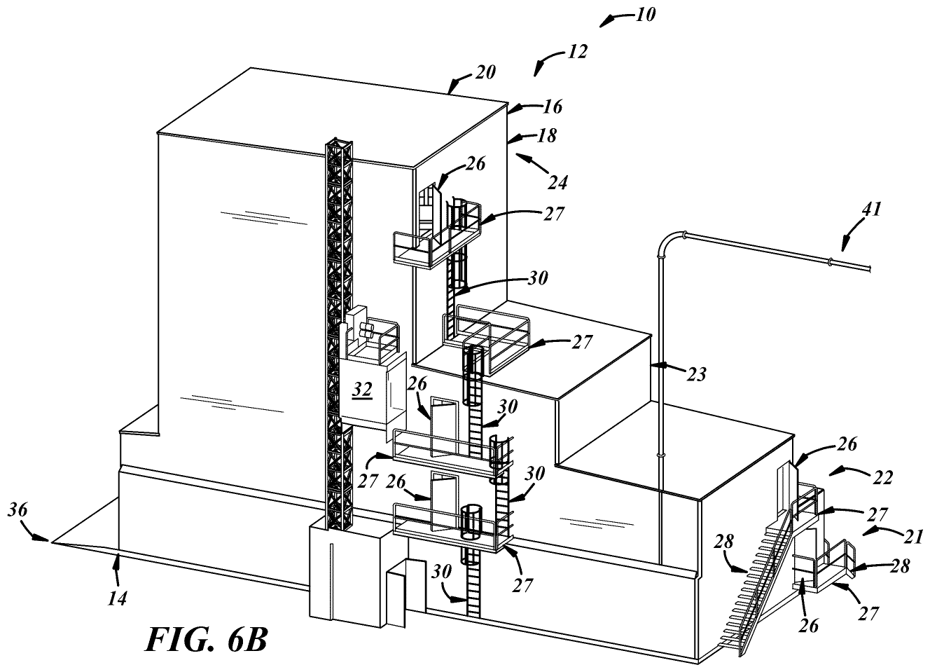

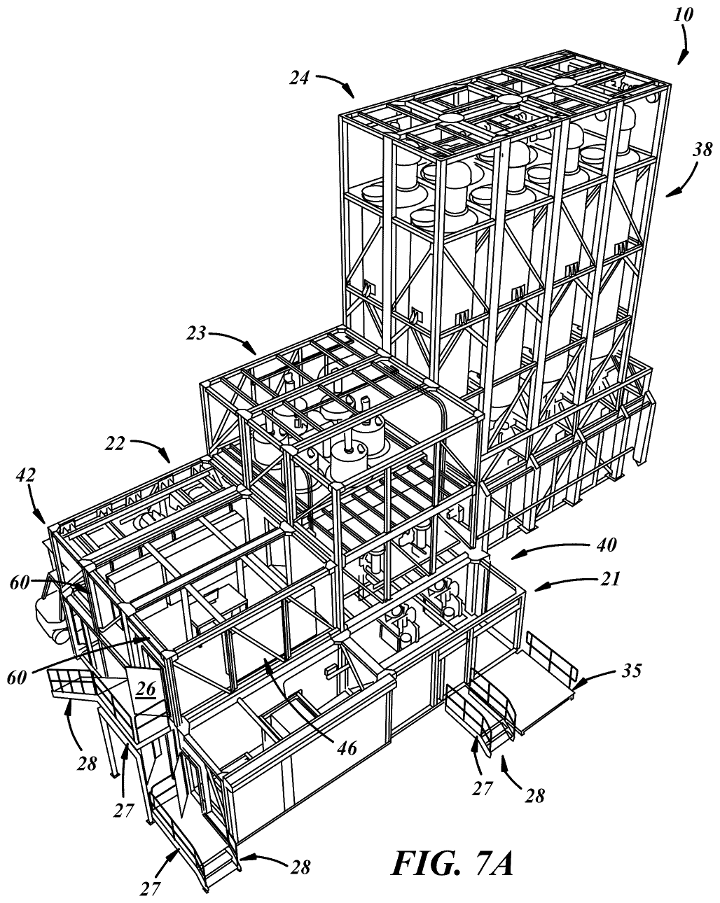

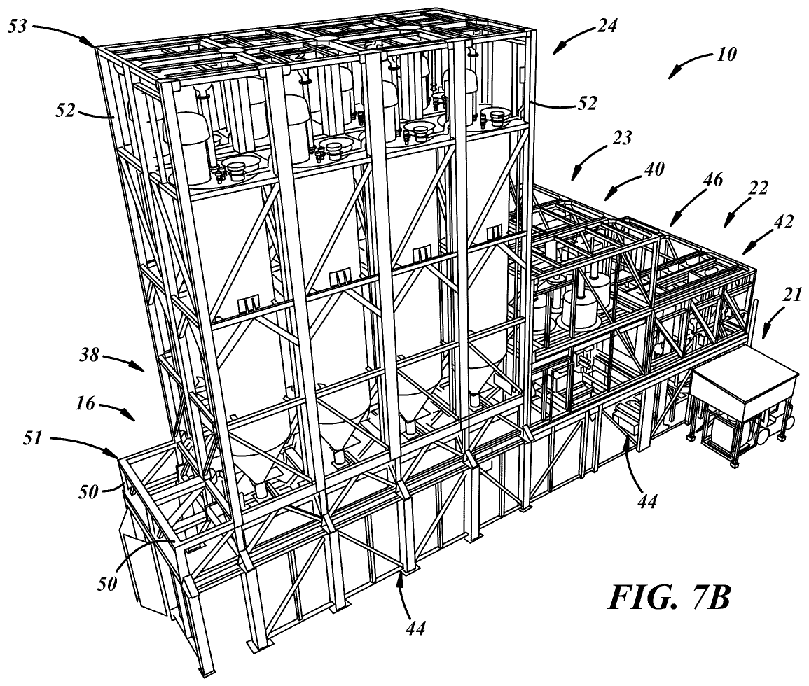

More specifically, with reference to FIGS. 1-5, the new architectural installation is much smaller than a conventional batch house installation. For example, the bulk material handling building 16 occupies a smaller footprint of about 3,500 square feet or about 325 square meters. The height of the new architectural installation may be about 54 feet (16.5 meters) to 57 feet (17.4 meters) above floor level, the length of the new architectural installation may be about 78 feet (23.8 meters) to 81 feet (24.7 meters), and the width of the new architectural installation may be about 33 feet (10.1 meters) to 35 feet (10.7 meters). In another example, with reference to FIGS. 6A and 7A, the bulk material handling building has a smaller volumetric envelope of about 189,000 cubic feet or about 5,350 cubic meters. Thus, the architectural installation of the new system occupies a footprint and volumetric envelope much smaller than that of conventional batch houses. As used herein, the term “about” means within plus or minus five percent.

The new bulk material handling system is sized to support production output of a glass manufacturing system or factory at about 110 TPD. Accordingly, a capacity-adjusted size of the presently disclosed bulk material handling system can be characterized by the volumetric envelope of the presently disclosed bulk material handling system divided by the glass production output supported by the system. For example, the bulk material handling building size of about 5,350 cubic meters is divided by 110 TPD for a capacity-adjusted size of about 49 cubic meters per each ton of glass produced per day by a glass manufacturing system supported by the bulk material handling system.

The capacity-adjusted size of the bulk material handling building is less than 50 cubic meters per each ton of glass produced per day by the glass container factory supported by the bulk material handling system, certainly less than 75 cubic meters per each ton of glass produced per day, and much less than the 125+ cubic meters per each ton of glass produced per day of the conventional factory. Accordingly, the capacity-adjusted size of the bulk material handling building is about 49 cubic meters per each ton of glass produced each day. Thus, the capacity-adjusted size of the presently disclosed bulk material handling building may be less than half, or even less than a quarter, that of the conventional batch house. Therefore, and because the presently disclosed system is modular, the system is particularly amenable to being scaled up to support any desired output. For instance, the system can be replicated in multiples, for example, to accommodate expansion of a glass factory supported by the system.

Additionally, although shown as a separate architectural installation in the drawing figures, at least a portion of the architectural installation of the bulk material handling system may be integrated with an architectural installation of hot and cold end systems of a glass container manufacturing plant. For example, a majors subsystem of the bulk material handling system and the enclosure and foundation portion of the bulk material handling building corresponding to the majors subsystem may be located outside of the architectural installation of the hot and cold end subsystems, and the rest of the bulk material handling system may be located within the enclosure of the architectural installation of the hot and cold end subsystems with no increase—and perhaps some decrease—in footprint or volumetric envelope described above. In another example, a weatherproof majors subsystem may be located outside of the architectural installation of the hot and cold end subsystems on a suitable foundation, and access to the majors subsystem may be provided by an above ground enclosed tunnel or hallway traversable by automatically guided vehicles.

With specific reference now to FIGS. 1-3, 6A, and 6B, a new bulk material handling system 10′ includes a new architectural installation 12′ and new subsystems and equipment supported and sheltered by the installation 12′. The installation 12′ includes a concrete foundation 14′ having a floor which may include, for example, a four to six-inch-thick slab, and a bulk material handling building 16′ on the foundation including walls 18′ and a roof 20′. The installation 12 requires no basement and no pit below the floor, such that the concrete foundation has earthen material directly underneath, wherein the foundation slab establishes the floor. As used herein, the term “pit” includes an elevator pit, conveyor pit, loading pit, and the like, located below grade or below ground level and that may require excavation of earthen material to form. As used herein, the term “basement” includes the lowest habitable level of the bulk material handling building below a floor of the building and can include a first level or a below grade or below ground level portion that may require excavation of earthen material.

With reference to FIGS. 6A and 6B, the installation 12′ also includes multiple habitable levels, including a base or first level 21, an intermediate or second level 22, an upper or third level 23, and an attic or fourth level 24. Also, as used herein, the term “habitable” means that there is standing room for an adult human in the particular space involved and there is some means of ingress/egress to/from the space while walking such as a doorway, stairway, and/or the like. The installation 12′ further includes egress doors 26, egress platforms 27, stairs 28, ladders 30, and an elevator 32 to facilitate access to the egress platforms 27 and doors 26. The installation 12 additionally includes loading doors 34 and loading platforms 35 and one or more ramps 36. Notably, the building 16′ is constructed of many modules, including modular walls used to construct a base frame for the first level, and modular frames for the second, third, and fourth levels, as will be discussed in detail below.

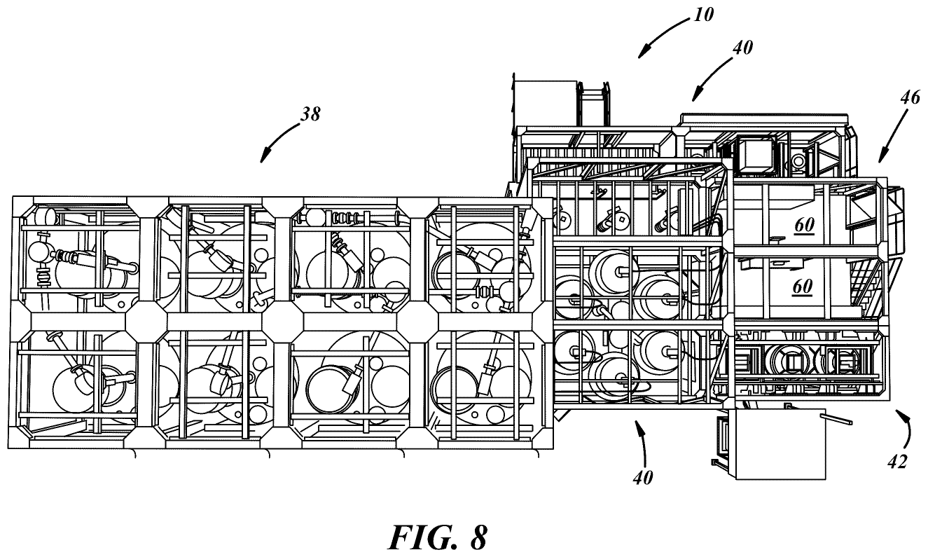

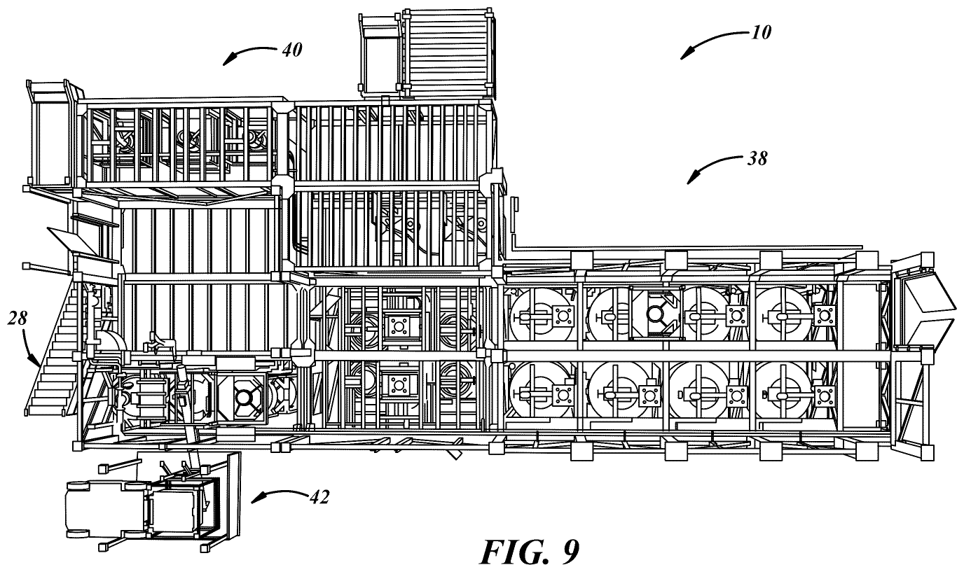

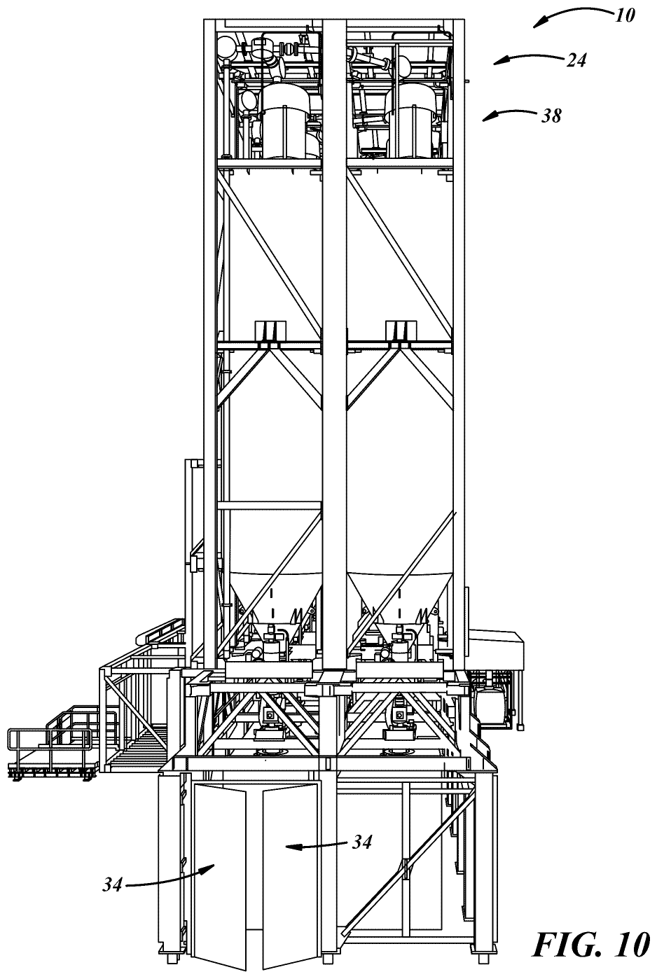

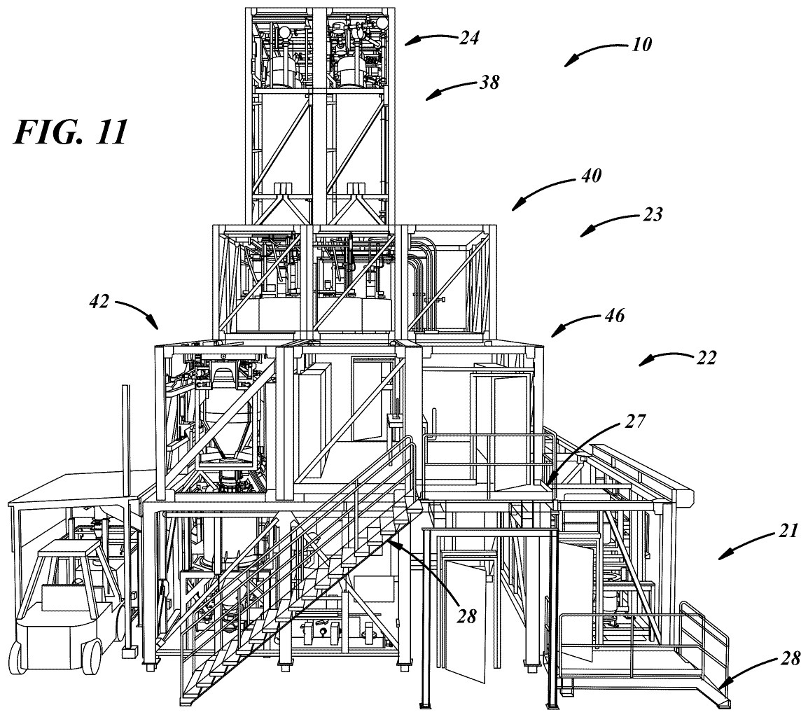

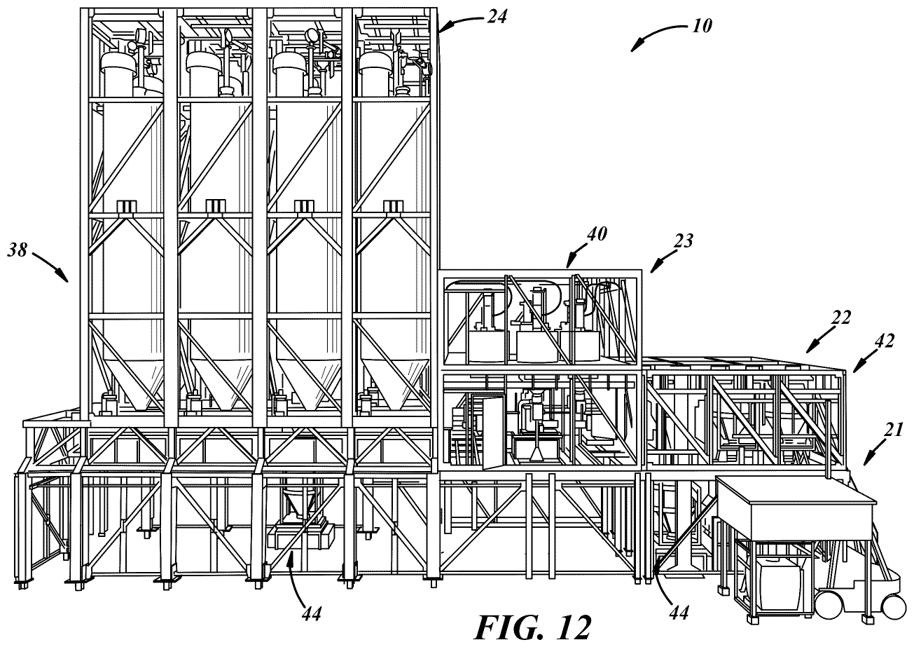

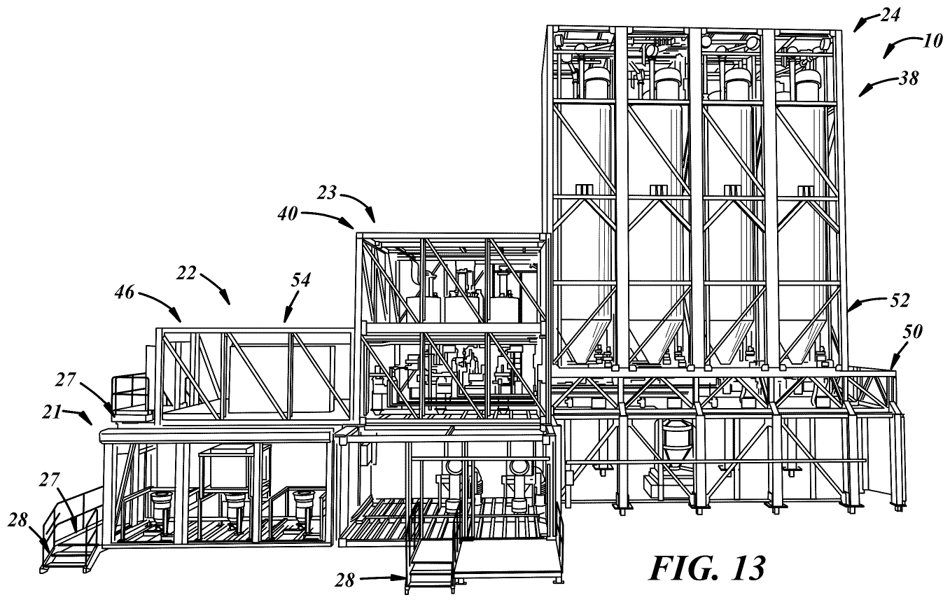

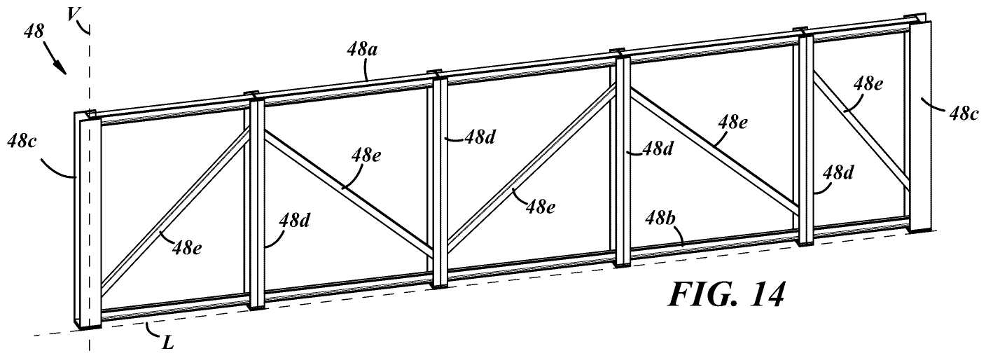

With reference to FIGS. 7A through 13 generally, a bulk material handling system 10 includes several subsystems that occupy a volumetric envelope much smaller than conventional batch houses such that the system 10 likewise requires a smaller volumetric envelope than conventional glass batch houses. The bulk material handling system 10 may be a glass bulk material handling system configured to receive and store glass feedstock or “glass batch.” The glass batch includes glassmaking raw materials, including glass feedstock “majors” and “minors” and also may include cullet in the form of recycled, scrap, or waste glass. The bulk material handling system receives glass batch bulk materials and combines them into doses and provides the doses to a downstream hot-end system of a glass factory adjacent to or part of the bulk material handling system.

The bulk material handling system 10 includes a new architectural installation 12 and new subsystems and equipment supported and sheltered by the installation 12. The installation 12 includes a concrete foundation 14 having a floor which may include, for example, a four to six-inch-thick slab, and a bulk material handling building 16 on the foundation including walls 18 and a roof 20. The system 10 is substantively the same as that previously described above with respect to FIGS. 1-5, with the exception that the system 10 may include fewer bulk handling storage containers. As will be described more specifically below with reference to the drawings, generally the system 10 may include only eight majors silos instead of 12 majors silos of the system 10′ of FIGS. 1-5. Despite the reduction in such quantity of storage containers, the system 10 is still capable of supporting production output of a glass manufacturing system or factory at about 110 TPD.

The system 10 includes one or more of the following subsystems. A first bulk material, or majors, subsystem 38 is configured to receive, pneumatically convey, store, and gravity dispense majors bulk material. Glassmaking majors may include sand, soda, limestone, alumina, saltcake, and, in some cases, dust recovery material. Similarly, a second bulk material, or minors, subsystem 40 is configured to receive, pneumatically convey, and store minors bulk material from individual bulk material bags. Glassmaking minors may include selenium, cobalt oxide, and any other colorants, decolorants, fining agents, and/or other minors materials suitable for glassmaking. A bulk material discharging subsystem 42 is configured to receive bulk material from the majors and minors subsystems 38, 40 and transmit the bulk material to downstream bulk material processing equipment, for example, a glass melting furnace separate from and downstream of the bulk material handling system 10. A bulk material transfer or transport subsystem 44 is configured to receive bulk material from the majors and minors subsystems 38, 40, and transport the bulk material within, to, and from, the majors and minors subsystems 38, 40, and to and from the discharge subsystem 42. A controls subsystem 46 is in communication with various equipment of one or more of the other subsystems 38, 40, 42, 44, and is configured to control various aspects of the system 10. Those of ordinary skill in the art would recognize that the system 10 can be supplied with utility or plant electrical power, and can include computers, sensors, actuators, electrical wiring, and the like to power and communicate different parts of the system 10 together. Likewise, the system 10 can be supplied with plant or compressor pneumatic power/pressure, and can include valves, lubricators, regulators, conduit, and other like pneumatic components to pressurize and communicate different parts of the system 10 together.

With reference to FIGS. 6A and/or 7A, the system 10 may be pneumatically closed from pneumatic input or receiving conduit 39 of the majors subsystem 38 to pneumatic output or transmitting conduit 43 of the discharging subsystem 42. The pneumatic receiving conduit 39 may extend through one or more walls 18 or roof 20 of the building 16 for accessibility to bulk transporters, e.g., trucks or rail cars (not shown), that bring bulk materials and that may have pressurized vessels to assist with pneumatic receiving and conveying of bulk material. The receiving conduit 39 has any suitable couplings for coupling to bulk transporters in a pneumatically sealed manner, wherein the bulk transporters may have pumps, valves, and/or other equipment suitable to pressurize the receiving conduit to push bulk material into the majors subsystem 38 and/or the batch handling system 10 itself may include pumps, valves, pressurized plant air plumbing, and/or other equipment suitable to apply positive and/or negative (vacuum) pressure to the input conduit to push and/or pull bulk material into the majors and minors subsystems 38, 40.

With reference to FIGS. 6B and/or 7B, the transmitting conduit 43 may extend through one or more walls 18 or the roof 20 of the building 16 for transmission to downstream bulk material processing equipment, for instance, in a hot end subsystem of a glass manufacturing system (not shown). For example, the transmitting conduit 43 is pneumatically sealingly coupled to a receiver hopper at a glass melter in the hot end subsystem (not shown). The conduit 43 may have any suitable couplings for coupling to the receiver hopper in a pneumatically sealed manner. Those of ordinary skill in the art would recognize that the bulk material handling system is pneumatically closed between the pneumatic receiving conduit and the pneumatic transmitting conduit. This is in contrast to conventional systems where bulk material is open to the surrounding environment. The phrase “pneumatically closed” means that the path, and the bulk materials following that path, from receiving conduit to transmitting conduit is/are enclosed, and not openly exposed to the surrounding environment, although not necessarily always sealed air-tight.

With reference now to FIG. 14, a representative modular wall 48 of the first level 21 of the building is constructed as a rectangular truss, having a longitudinal axis L and a vertical axis V, and including lower and upper beams 48a, b extending longitudinally and being vertically opposed from one another. The wall 48 also includes vertically extending end posts 48c and intermediate posts 48d longitudinally between the end posts 48c, and struts 48e extending obliquely between the beams 48a, b and connected to the posts 48c, d. The modular wall 48 may be preassembled at an equipment fabricator, shipped from the fabricator to a product manufacturer, and erected at the product manufacturer. The modular wall 48 may have exterior dimensions less than or equal to exterior dimensions of an intermodal freight container, more specifically, a height less than or equal to 9′ 6″ (2.896 m), a width less than or equal to 8′6″ (2.591 m), and a length less than or equal to 53′ (16.154 m). With reference again to FIG. 7B, the modular wall 48 may be used as a portion of a base frame establishing the habitable first level 21 of the system 1 and spanning the majors subsystem 38, the minors subsystem 40, and the discharging subsystem 42.

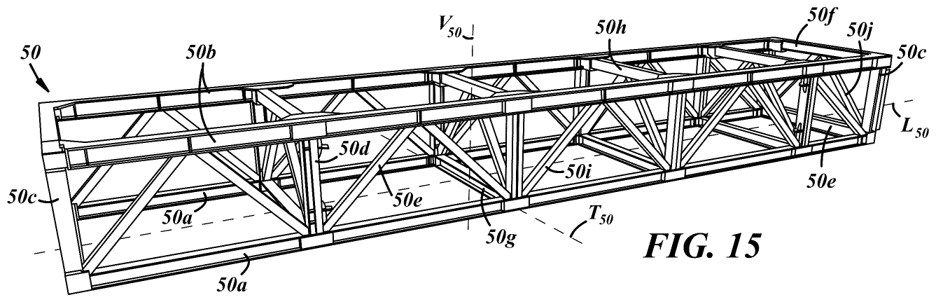

With reference now to FIG. 15, a representative horizontal or dispensing modular frame 50 is constructed as a rectangular box truss, having a longitudinal axis L₅₀, a transverse or lateral axis T₅₀, and a vertical axis V₅₀, including lower beams 50a extending longitudinally and being laterally opposed from one another, and including upper beams 50b extending longitudinally and being laterally opposed from one another. The frame 50 also includes posts 50c, d extending vertically between the lower and upper beams 50a, b and, more specifically, may include corner posts 50c extending vertically between ends of the lower and upper beams 50a, b, and intermediate posts 50d extending vertically between intermediate portions of the lower and upper beams 50a, b between the ends thereof. The frame 50 also includes lower end cross-members 50e extending laterally between the lower beams 50a, and upper end cross-members 50f extending laterally between the upper beams 50b. Likewise, the frame 50 also may include lower intermediate cross-members 50g extending between portions of the lower beams 50a between the ends thereof, and upper intermediate cross-members 50h extending between portions of the upper beams 50b between the ends thereof. The frame 50 may also include one or more side struts 50i extending obliquely between the lower and upper beams 50a, b and end struts 50j extending between lower and upper end cross-members 50e, f opposite longitudinal ends of the frame 50. The modular frame 50 may have exterior dimensions less than or equal to exterior dimensions of an intermodal freight container, more specifically, a height less than or equal to 9′ 6″ (2.896 m), a width less than or equal to 8′ 6″ (2.591 m), and a length less than or equal to 40′ (16.154 m).

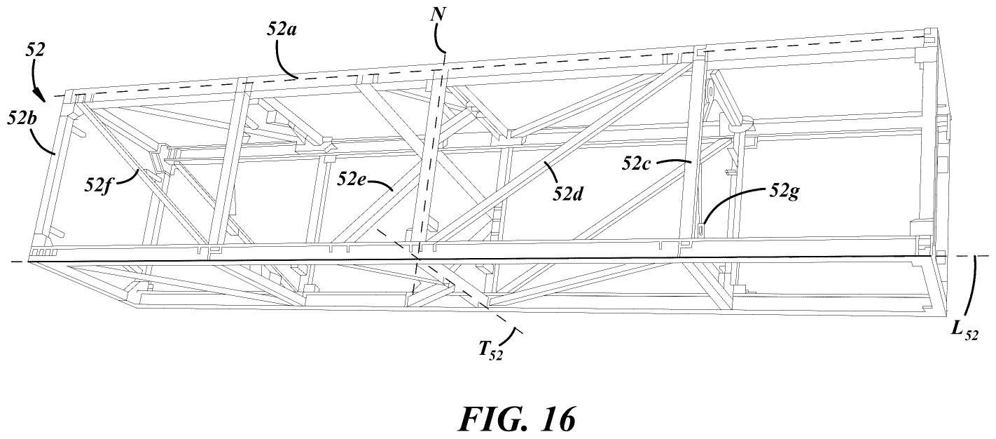

With reference now to FIG. 16, a representative vertical or silo modular frame 52 is constructed as a rectangular box truss, having a longitudinal axis L₅₂, a transverse or lateral axis T₅₂, and a normal axis N, and including corner beams 52a extending longitudinally, and being laterally and normally opposed from one another, and end cross-members 52b and intermediate cross-members 52c extending laterally and normally between the beams 52a. The frame 52 also includes one or more longer struts 52d extending obliquely between the beams 52a and may be attached to the beams 52a. The frame 52 further includes one or more shorter struts 52e extending between the beams 52a and a corresponding cross-member 52c, and one or more intermediate struts 52f extending between the beams 52a and coupled thereto. Finally, the frame 52 also may include platform brackets 52g coupled to upper intermediate cross-members 52c and configured to support a platform (not shown) thereon to establish a habitable attic level of the system. The modular frame 52 may have exterior dimensions less than or equal to exterior dimensions of an intermodal freight container, more specifically, a height less than or equal to 9′ 6″ (2.896 m), a width less than or equal to 8′ 6″ (2.591 m), and a length less than or equal to 40′ (12.192 m).

With reference to FIG. 7B, the majors subsystem 38 includes a dispensing level frame 51 constituted from two of the horizontal modular dispensing frames 50 of FIG. 15 situated side-by-side and carried on the base frame, and a storage container frame constituted from eight of the vertical modular storage container frames 52 of FIG. 16 situated in a 4×2 array carried on the dispensing level frame.

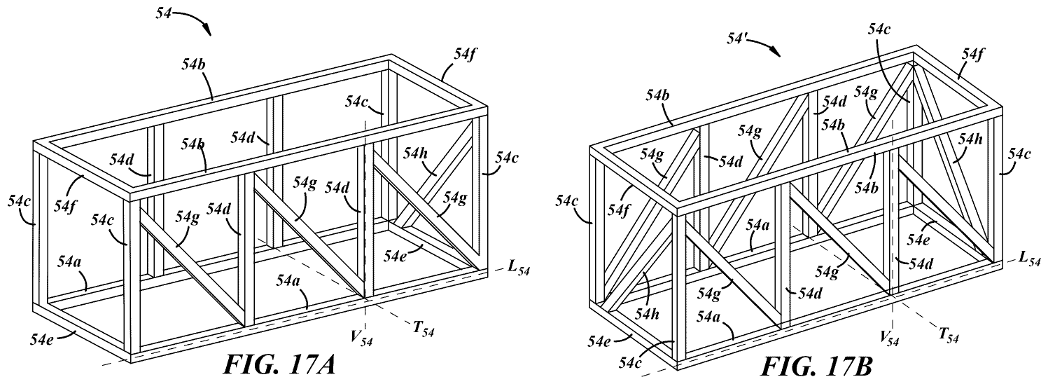

With reference to now FIG. 17A, a representative horizontal or multi-purpose modular frame 54 is constructed as a rectangular box truss, having a longitudinal axis L₅₄, a transverse or lateral axis T₅₄, and a vertical axis V₅₄, including lower beams 54a extending longitudinally and being laterally opposed from one another, and including upper beams 54b extending longitudinally and being laterally opposed from one another. The frame 54 also includes posts 54c, d extending vertically between the lower and upper beams 54a, b. The posts 54c may include corner posts 54c extending vertically between ends of the lower and upper beams 54a, b, and intermediate posts 54d extending vertically between intermediate portions of the lower and upper beams 54a, b between the ends thereof. The frame 54 also includes lower end cross-members 54e extending laterally between the lower beams 54a, and upper end cross-members 54f extending laterally between the upper beams 54b. Although not shown, the frame 54 also may include lower intermediate cross-members extending between intermediate portions of the lower beams 54a between the ends thereof. The frame 54 may also include one or more struts 54g, h extending obliquely between the lower and upper beams 54a, b, for example, side struts 54g extending between lower and upper beams 54a, b on opposite lateral sides of the frame 54 and may be coupled to the beams 54a, b and/or posts 54c, d, and/or may include end struts 54h extending between lower and upper end cross-members 54e, f on one or both longitudinal ends of the frame 54. With reference to FIG. 17B, another multi-purpose modular frame 54′ may be arranged to add struts 54g, h such that the quantity and arrangement of struts 54g, h may be configured for particular application locations for example, where earthquake, high winds, and/or snow are prevalent. The modular frames 54, 54′ may have exterior dimensions less than or equal to exterior dimensions of an intermodal freight container, more specifically, a height less than or equal to 9′ 6″ (2.896 m), a width less than or equal to 8′ 6″ (2.591 m), and a length less than or equal to 20′ (6.096 m), such that two modules 54, 54′ could be laid end to end and be shipped like a 40′ intermodal freight container.

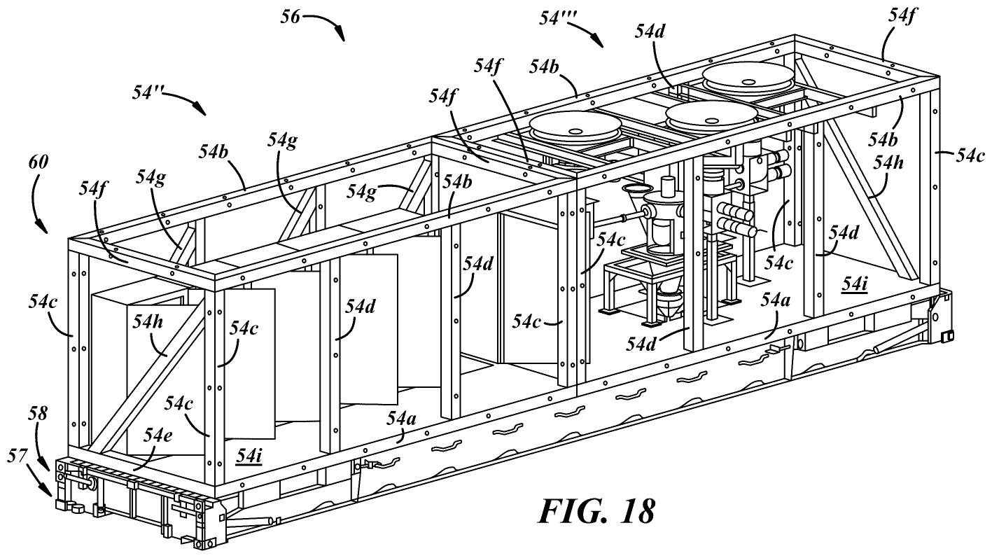

With reference now to FIG. 18, two or more multi-purpose modular frames 54″, 54′″ or any of the other modular frames 50, 52, 54, 54′ (FIGS. 15-17B) disclosed herein may share common exterior dimensions such that the frames can be carried together on a common pallet, and can be easily aligned with one another to facilitate positioning and assembling them together on site. In fact, many of the modular frames may share identical exterior dimensions. More specifically, FIG. 18 illustrates modules 56 including the modular frames 54″, 54′″ that can be shipped on a standard seagoing flat rack 57 like a Mafi trailer or the like to constitute a rack and module assembly 58. On trucks, the modular frames 54″, 54′″ (shipped as modules with equipment carried by the modular frames) are designed to be self-supporting and may be wrapped in plastic foil or sheet or truck tarpaulins (not shown) to seal against dust, dirt, and sea water/air, and bottoms and tops may be covered with planks or sheets (not shown) of wood, metal, or plastic to protect the equipment in the modules 56. On ships, the modules 56 may be placed on the rack 57 and rolled onto a roll on/roll off ship at a departure seaport and, at an arrival sea port, the rack 57 is rolled off the ship and the modules 56 are placed on a truck. Accordingly, the modules 56 can be placed in a closed belly of the ship and not be exposed to sea water. The frames 54″, 54′″ also may include a platform 54i carried on the lower beams 54a and the lower cross-members 54e to establish a floor. The platform 54i may be constructed from a single panel or multiple panels.

U.S. Patent Application Publication 2022/0106104, was filed on Oct. 1, 2021 and given Ser. No. 17/492547, is assigned to the assignee hereof, and is incorporated herein by reference in its entirety.

U.S. Pat. No. 12,246,926, was filed on Oct. 1, 2021 and given Ser. No. 17/492,548, is assigned to the assignee hereof, and is incorporated herein by reference in its entirety.

U.S. Patent Application Publication 2022/0106106, was filed on Oct. 1, 2021 and given Ser. No. 17/492,549, is assigned to the assignee hereof, and is incorporated herein by reference in its entirety.

U.S. Patent Application Publication 2022/0106135 was filed on Oct. 1, 2021 and given Ser. No. 17/492,550, is assigned to the assignee hereof, and is incorporated herein by reference in its entirety.

With reference in general to all drawings of the drawing figures, one of ordinary skill in the art would recognize that the above-described systems, subsystems, apparatuses, and components, enable various bulk material handling methods, at least as follows. A bulk material handling method includes receiving bulk material and pneumatically conveying the bulk material via at least one of pressurized dilute phase, pressurized dense phase, hybrid dilute/dense phase, or vacuum draw conveyance into bulk material containers, and storing the bulk material in the bulk material containers. The method also includes dispensing the bulk material from the bulk material containers into a bulk material transporter, and transporting the bulk material transporter from the bulk material containers to a bulk material discharging system. The method further includes discharging the bulk material out of the bulk material transporter, including releasing the bulk material from the bulk material transporter into a bulk material transmitting vessel, and pneumatically transmitting the bulk material out of the bulk material transmitting vessel to downstream bulk material processing equipment.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A method of constructing a bulk material handling system, comprising:
pre-assembling modules of the bulk material handling system at an equipment fabricator;
shipping the modules of the pre-assembled system from the fabricator to a product manufacturer using intermodal freight containers; and
erecting the pre-assembled system from the modules at the product manufacturer.

2. The method set forth in claim 1, wherein the modules include
a majors dispensing module including a majors dispensing frame carrying majors dispensing equipment;
a plurality of majors container modules including majors container frames carried on the majors dispensing frame and carrying the majors containers;
a minors dispensing module including a minors dispensing frame carrying minors dispensing equipment; and
a minors containing module including a minors containing frame carried by the minors dispensing frame and carrying the plurality of minors containers.

3. A bulk material handling method, comprising:
receiving bulk material and pneumatically conveying the bulk material via at least one of pressurized dilute phase, pressurized dense phase, hybrid dilute/dense phase, or vacuum draw conveyance into bulk material containers;
storing the bulk material in the bulk material containers;
dispensing the bulk material from the bulk material containers into a bulk material transporter;
transporting the bulk material transporter from the bulk material containers to a bulk material discharging system; and
discharging the bulk material out of the bulk material transporter, including
releasing the bulk material from the bulk material transporter into a bulk material transmitting vessel, and
pneumatically transmitting the bulk material out of the bulk material transmitting vessel to downstream bulk material processing equipment.

4. The method of claim 3, wherein the discharging also includes:
rejecting the bulk material from the bulk material transporter to a waste container.

5. The method of claim 3, wherein the entire method is carried out in a volumetric envelope of less than 7,500 cubic meters and produces about 110 tons of glass per day, for a capacity adjusted size of less than 70 cubic meters per each ton of glass produced per day.

6. The method of claim 3, wherein the entire method is carried out in a volumetric envelope of less than 6,000 cubic meters and produces about 110 tons of glass per day, for a capacity adjusted size of less than 55 cubic meters per each ton of glass produced per day.

7. The method of claim 3, wherein the entire method is carried out in a volumetric envelope of about 5,350 cubic meters and produces about 110 tons of glass per day, for a capacity adjusted size of less than 50 cubic meters per each ton of glass produced per day.
